(19) United States
(12) Patent Application Publication
(10) Pub. No.: US 2014/0048587 A1
(43) Pub. Date: Feb. 20, 2014

(54) BRAZING ALLOY AND PROCESSES FOR MAKING AND USING

(71) Applicants: Paul Rivest, Carmel, IN (US); Robert Biersteker, Hilbert, WI (US); Joseph Sarazin, DePere, WI (US)

(72) Inventors: Paul Rivest, Carmel, IN (US); Robert Biersteker, Hilbert, WI (US); Joseph Sarazin, DePere, WI (US)

(21) Appl. No.: 13/761,663

(22) Filed: Feb. 7, 2013

Related U.S. Application Data
(60) Provisional application No. 61/595,814, filed on Feb. 7, 2012.

(51) Int. Cl. B23K 35/30; B32B 15/01

(52) U.S. Cl. CPC B23K 35/302; B32B 15/01
USPC 228/256; 428/576; 428/586; 428/674; 420/477; 148/24; 164/47; 164/69.1

(57) ABSTRACT

Disclosed is a brazing alloy composition. The composition comprises, by weight, about 94% copper, about 4% zinc, and about 2% iron. Further disclosed is a brazing process utilizing the brazing alloy, a method for the brazing alloy's preparation and a work piece having members joined by the brazing alloy providing stronger bonding as demonstrated by braze joints having increased shear strength.

### CROSS-REFERENCE TO RELATED APPLICATIONS

This application claims the benefit of U.S. Provisional Application No. 61/595,814, filed Feb. 7, 2012, and incorporates all by reference herein, in its entirety.

### BACKGROUND

This disclosure relates, in general, to an alloy capable of being used to braze joints between two or more metal surfaces. Brazing typically consists of joining metal surfaces by fusing a filler metal between the metal surfaces without appreciable mixing of the metal composing the surfaces. The filler metal has a lower melting point than the metal(s) being joined (the “base metal(s)”). Additionally, a brazing flux may be applied to the metal surfaces either prior to or simultaneously with the filler metal.

Typically, a brazing flux flows at a temperature somewhat below the melting point of the filler metal; adheres to or wets the metal surfaces; facilitates the flow and wetting of the filler metal over the subject metal surfaces generally by reducing the surface tension of the molten filler metal; removes any oxide coating or other adherent foreign matter present on the subject metal surfaces without appreciably attacking the metal surfaces; inhibits re-oxidation of the subject metal surfaces; and is capable of ready displacement by the filler metal. Usually, the brazing flux leaves a readily removable and relatively inert residue after completion of the brazing. Some brazing flux materials may leave no substantially appreciable residue after brazing.

Furnace brazing in a controlled atmosphere without a flux can offer several advantages. For example, the possibility of flux inclusions is eliminated, and accordingly, blind cavities, tortuous paths, and small passageways can be designed into the assembly without regard to flux removal or entrapment after brazing. In addition, brazing without a flux eliminates: (a) the cost of flux; (b) the application of the flux; (c) the need for cleaning the assembly after brazing; and (d) potential corrosion of equipment and pollution of air and water by flux residues or flux reaction products. Apart from compatibility with the metal or metals composing the metal surfaces, brazing metals are typically selected based upon melting point, wetting properties, corrosion resistance, resulting strength of the brazed joints, and suitability for intended use of the joined metal surfaces.

Increasingly, materials used in structural applications are also required to be capable of withstanding high temperatures and corrosive and abrasive environments. In some applications, carbon steels, stainless steels and nickel base alloys have been used to meet the requirements of high temperature and corrosive resistance while maintaining a high strength to weight ratio. However, one obstacle to the use of the stainless steels and nickel base alloys is the difficulty of obtaining satisfactory joints between surfaces composed of these materials. Failure to achieve a proper joint or bond requires reworking or results in scrap.

The amount of brazing metal applied to a joint area is normally controlled to avoid having the filler metal flow into areas where it is neither needed nor wanted. Also, it is often advantageous to have the brazing metal be compatible with the optimum heat treatment temperature of the base metals. However, known filler metals for nickel-base alloys, often fail to provide good wetting with limited flow, at brazing temperatures such that joints are sealed without filler material flowing into internal passage of the components. Additionally, many brazing materials do not have the proper wetting and flow characteristics (resulting in puddling and melt-flow away from the joint), at brazing temperatures and can also fail in providing high temperature, corrosion and abrasion resistance. Furthermore, those brazing metals that do provide the desired flow characteristics frequently melt at temperatures high enough to cause interactions with the base metals such as alloying with the filler metal. Strong bonds generally require a minimum gap to be filled by the braze material, such as for example a press fit. As gaps increase beyond a press fit, bond strength typically decreases, ultimately failing as the gap continues to increase. As a result, gap variations typically lead to fluctuations in joint or bond strength and unsatisfactory work pieces.

### SUMMARY

The disclosure which follows provides a work piece formed in a brazing operation utilizing a novel brazing alloy that provides improved joint quality, appearance, and strength. The brazing process utilizing the new brazing alloy to form the work piece provides:
Increased productivity, resulting from fewer reworks,
Improved wetting into weld joints with reduced puddling,
Strong, consistent and reproducible bonding,
Cost savings resulting from reduced energy consumption resulting from fewer reworks,
Less scrap resulting from fewer unsatisfactory work pieces,
Improved throughput, and
The elimination of a need to use a flux.
   A method for the production of the new brazing alloy is additionally provided.

The brazing alloys of the present disclosure typically comprises at least about 86 wt. % copper, about 0.1-10 wt. % zinc, and about 0.1-4 wt. % iron. The brazing process utilizing these alloys typically involves applying the brazing alloy to a region proximate two metal surfaces to be joined; heating the proximate region sufficiently to cause the brazing alloy to melt and flow between the two metal surfaces; and cooling to form joined surfaces. The at least 86 wt. % copper or other sources of copper typically includes incidental impurities commonly present in copper such as up to a total of 1% of silicon, manganese, aluminum, nickel, and phosphorous, and these amounts of impurities are included in the at least about 86 wt. % copper.

The brazing alloy can be formed by traditional metal working practices of combining appropriate amounts of the alloy's components, heating the mixture of components to a temperature sufficiently high to melt all components and cast to form a solid alloy in billet or continuously cast shapes. A wrought form of the alloy can be prepared by cold or hot working the alloy to form rods, tubes, and the like or rolled or pounded to form sheets or foil alloy. A powdered form of the alloy can also be prepared by grinding an alloy billet, cast form, or any form of the alloy derived from the billet or cast form. The powdered form may then be mixed into a gel, past, cream, or other suitable medium.

A first aspect of this present disclosure involves a copper-based brazing alloy that includes about 0.1 to 10 wt. % zinc, about 0.1 to about 4 wt. % iron, and the balance copper. In certain embodiments, a corresponding portion of the copper can be replaced by generally small amounts (typically less than about 1 wt. %) of the following elements in the quantities noted:
up to about 0.7 wt. % silicon,
up to about 0.7 wt. % manganese,
up to about 0.7 wt. % aluminum,
up to about 0.7 wt. % nickel,
up to about 0.7 wt. % phosphorous, and
up to about 0.2 wt. % titanium.
   The addition of any of these minor components is carried out at the expense of the total amount of copper, causing the balance of copper in the alloy to include copper and any of these additional components in the amounts noted. For example, were 0.2 wt. % of titanium to be added to an alloy initially containing 94 wt. % copper, the copper content would be reduced to 93.8 wt. %. The brazing alloy can have a wrought form or a powder form. The wrought forms of the alloy can have the shape of a wire, a strip, a tube, a slug, and a foil.

A further aspect of the present disclosure involves a brazing process including the steps of providing members having at least two surfaces adapted for bonding and a brazing alloy; positioning a brazing alloy proximate the at least two surfaces adapted for bonding; heating the at least two members and the brazing alloy to a temperature sufficient to melt the brazing alloy; and cooling the members and the brazing alloy to solidify the brazing alloy. The brazing alloy provided includes about 0.1 to 10 wt. % zinc, about 0.1 to about 4 wt. % iron, and the balance copper, and has a melting temperature lower than the melting temperature of the members. The brazing alloy provided can be the brazing alloy described above having a wrought form or a powder form. The wrought alloy can take the form of a wire, a strip, a tube, a slug, any other suitable shape, or a foil. The powder form can be provided as a paste including a binder and optionally a flux and the like. One specific example of the brazing alloy includes about 4 wt. % zinc, about 2 wt. % iron, and about 94 wt. % copper. Suitable brazing temperatures typically range from about 1910° F. to about 2300° F.

A further aspect of this current disclosure involves a method for preparing Applicants' brazing alloy. The method involves forming a mixture containing about 0.1 to about 4 wt. % iron, about 0.1 to about 10 wt. % zinc, and the balance copper, heating the mixture to a temperature sufficient to form a homogeneous molten mass; transferring the molten mass into a three-dimensional form and solidifying the molten mass by cooling. The resulting solid can be transformed into a wrought form by working the solid or grinding it into a powder. Working of the alloy can be carried out cold, at elevated temperatures, and combinations thereof. In the examples that follow, the method was utilized to prepare and test a wrought form of an alloy including about 4 wt. % zinc, about 2 wt. % iron, and about 94 wt. % copper. The disclosed method could also be used to make brazing alloys having other compositions which fall within the general range of about 0.1 to about 4 wt. % iron, about 0.1 to about 10 wt. % zinc, and the balance copper.

A still further aspect of this current disclosure involves a work piece including two members (typically involving one or more base metals) joined by a brazing alloy that includes about 0.1 to 10 wt. % zinc, about 0.1 to about 4 wt. % iron, and the balance copper. Specific work pieces were prepared and tested utilizing a brazing alloy including about 4 wt. % zinc, about 2 wt. % iron, and about 94 wt. % copper. The work pieces formed, tested, and which demonstrated superior bonding involved members having a gap of ≧0.002″ filled with the brazing alloy. Superior bonding was demonstrated by the determinations of shear strength for the resulting braze joint. Similar improved work pieces can be formed with a brazing alloy of the composition described above that further contains up to about 1 wt. % of individual components selected from the group consisting of silicon, manganese, aluminum, nickel, phosphorous, titanium, and combinations thereof. As noted above, these additional elements are added at the expense of the total copper added. When titanium is selected as an additional alloy component, amounts of titanium in the order of about 0.2 wt. % are utilized. Work pieces having gaps between members greater than a press fit, typically greater than about 0.002 of an inch and more typically ranging from about 0.002 to about 0.003 of an inch and brazed with Applicants' claimed alloy typically provide joints that demonstrate shear strengths of at least about 30 ksi. Examples of suitable work pieces include a torque converter, a muffler bracket, a fuel rail, an aircraft component, a water craft component, and a farm equipment component or other components of mechanical devices or machines. All per cents indicated herein are weight per cents.

### BRIEF DESCRIPTION OF THE DRAWINGS

FIG. 1 provides a schematic view of the components of a work piece prepared for a brazing process illustrating it members and the brazing alloy.

FIG. 2 provides a schematic view of a brazed work piece where the gap between members was greater than a press fit, and the braze alloy was CDA 110, illustrating the failure to form a bond, and puddling of the braze alloy.

FIG. 3 provides a schematic view of a brazed work piece where the gap between members was greater than a press fit, and the braze alloy was CDA 102, illustrating a gap incompletely filled and puddling of the braze alloy.

FIG. 4 provide provides a schematic view of a brazed work piece where the gap between members was greater than a press fit, and the braze alloy was the alloy from Example, illustrating a uniformly filled gap and the absence of puddling.

FIG. 5 provides a graphical illustration of the data included in Table I illustrating the shear stress determined for work pieces formed from members having gaps between members ranging from a press fit, 0.002″, and 0.003″ and infiltrated with CDA 102, CDA 110, and the alloy from Example 1.

FIG. 6 provides a graphical illustration of the data included in Table II illustrating the shear stress standard deviations determined for work pieces formed from members having gaps between members ranging from a press fit, 0.002″, and 0.003″ and infiltrated with CDA 102, CDA 110, and alloy from Example 1.

### DESCRIPTION

According to the present disclosure, any suitable metal can be brazed using the novel brazing alloy described herein. Particularly suitable metals include, for example, iron based materials including carbon steels, stainless steels and nickel-base alloys. Brazing alloys according to this disclosure can include at least about 86 wt. % copper, more particularly at least about 0.1 wt. % zinc, and at least about 0.1 wt. % iron and the balance copper. Such brazing alloys provide desirable properties which include, but are not limited to good wetting properties, flow, and gap filling characteristics, sufficient viscosity to provide limited and controlled flow properties, as well as advantageous joint strength, corrosion resistance and abrasion resistance. In addition, the brazing alloys of the current disclosure leave little or no brazing residue. The brazing alloys of the present disclosure melt in the range of from about 1910° F. to about 2300° F., depending on the alloy's composition. Furthermore, brazing using the disclosed brazing alloys can be carried out in a continuous furnace under a variety of conditions.

A first aspect of this present disclosure involves a copper-based brazing alloy including about 0.1 to about 4 wt. % iron, about 0.1 to about 10 wt. % zinc, and the balance copper. The “balance copper” can contain trace impurities typically found in sources of copper metal. Additionally, certain other embodiments of this brazing alloy can still further include less than about 1 wt. % of individual components selected from the group consisting of silicon, manganese, aluminum, nickel, phosphorous, titanium, and combinations thereof, and the balance copper. Finally, certain embodiments of this brazing alloy can still further include up to about 0.2 wt. % of titanium. The alloy can be prepared in forms including, but not limited to a wrought form (such as, for example, a wire, a strip, a tube, foil, slug and the like) or a powder. A wrought form of the alloy refers to a form of the alloy that has been worked, either cold, hot, or combinations thereof, to alter the alloys shape and properties.

A further aspect of the present disclosure involves a brazing process utilizing the disclosed alloy. The process involves providing members having at least two surfaces adapted for bonding and a brazing alloy; positioning a brazing alloy proximate the at least two surfaces adapted for bonding; heating the at least two members and the brazing alloy to a temperature sufficient to melt the brazing alloy; and cooling the members and the brazing alloy to solidify the brazing alloy. The brazing alloy provided comprises about 0.1 to 10 wt. % zinc, about 0.1 to about 4 wt. % iron, and the balance copper (including typical trace impurities); and has a melting temperature lower than the members. The members to be bonded have a melting point higher than the brazing temperature, and higher than the brazing alloy's melting temperature. Improved results can be obtained by brazing clean and dry surfaces in a dry atmosphere. Alternatively, a brazing flux can be used as part of the brazing process whereby the brazing flux acts to clean and maintain a suitable surface during the brazing.

A still further aspect of the present disclosure involves a work piece including two members joined by a brazing alloy that includes about 0.1 to 10 wt. % zinc, about 0.1 to about 4 wt. % iron, and the balance copper. Other work pieces can be joined by a brazing alloy that includes about 4 wt. % zinc, about 2 wt. % iron, and about 94 wt. % copper. Work pieces can also be joined by a brazing alloy that further includes less than about 1 wt. % of individual components selected from the group consisting of silicon, manganese, aluminum, nickel, phosphorous, titanium, and combinations thereof, and the balance copper. Certain work pieces of this last type can be joined by a brazing alloy including up to about 0.2 wt. % of titanium. Finally, certain work pieces can be joined by Applicants' brazing alloy through a gap between the two members of at least press fit. Other work pieces can be joined by Applicants' brazing alloy through a gap between members ≧0.002 of an inch.

One still further aspect of the present disclosure involves a method for forming the disclosed alloy in a three dimensional wrought or powder form. The method comprises forming a mixture containing about 0.1 to about 4 wt. % iron, about 0.1 to about 10 wt. % zinc, and the balance copper; heating the mixture to a temperature sufficient to form a homogeneous molten mass, casting the molten mass into a solid form followed by a combination of cold working and annealing or hot working.

The present disclosure will be further illustrated by the following examples in which parts and percentages are by weight unless otherwise specified.

### Example 1

### Brazing Alloy

### Preparation of a Brazing Alloy:

A mixture containing 93.7 parts by weight copper, 4.3 parts by weight zinc and 2 parts by weight iron was heated to about 2100° F. to form a homogeneous melt or molten mass. The molten mass was continuously cast into rod form, cold worked and annealed into desired wire form. In a similar manner castings or billets can be extruded to form tubes or rolled to form sheets or foil. The rods formed were drawn into a wire suitable for use as a brazing alloy. Similarly, the rods formed can be rolled to form sheets (foil) and other forms of the alloy. In addition, powdered alloy can be derived at various points following formation of the cast material. Wire, tubes or strip forms of the alloy can be wound onto spools and the like to simplify transportation, storage and handling. Because the wires have a generally uniform density, the weight of brazing alloy can be conveniently related to the length of a section of wire or ribbon. Copper alloys having as little as about 86 weight % copper, about 0.1 to about 10 weight % zinc and about 0.1 to about 4 weight % iron can be prepared according to this method and formed into the various forms of wrought and/or powdered alloy suitable for brazing. Wrought forms of the brazing alloy can include a wire, strip, tube, slug, foil, and the like. Brazing alloys prepared according to this method have been found to be suitable for brazing iron-based materials.

### Example 2

### Brazing an Iron-Based Material

### General Brazing Procedure:

Components to be joined and made of an iron-based material can be cleaned by degreasing with a common solvent. The components can then be rinsed thoroughly and bake-dried. A wire form of a brazing material which comprises, by weight, about 4.3 wt. % zinc; about 2 wt. % iron, and the balance copper, is positioned proximate the areas to be joined.

The components are then heated to about 1,950° F. and held for about one hour. Heating is then continued up to about 2070° F. (the brazing temperature) and held for up to about 11 minutes. The temperature is then reduced to about 1,950° F. and held for about 2 hours. After backfilling the chamber with chemically inert gas, the component is removed at about 400° F. and is air cooled. The clean dry brazed component is ready for use or further processing as soon as it is cool. The brazing process described above can similarly be carried out with a brazing alloy having a strip, tube, a slug or powder form.

### Example 3

### Brazing Steel Material

### Example of Brazing Process and Resulting Work Pieces

A series of two members including carbon steel plates (0.375 of an inch thick) and pins (0.500 of an inch diameter) were cleaned as described above, and a hole was provided in the center of each plate sized (a) for a press fit of a pin, (b) to provide a 0.002 of an inch clearance of the pin, and (c) to provide a 0.003 of an inch clearance of the pin. The pins were inserted into the steel plates through a hole and a wire ring of brazing alloy selected from the group including the alloy from Example 1, CDA 102 alloy, and CD 110 alloy was positioned about the upper intersection of members. CDA 102 alloy is an oxygen free copper alloy including a minimum of 99.95 wt. % copper. CDA 110 alloy is referred to as an ETP copper electrolytic touch pitch that includes a minimum of 99.90 wt. % copper (0.05 oxygen maximum).

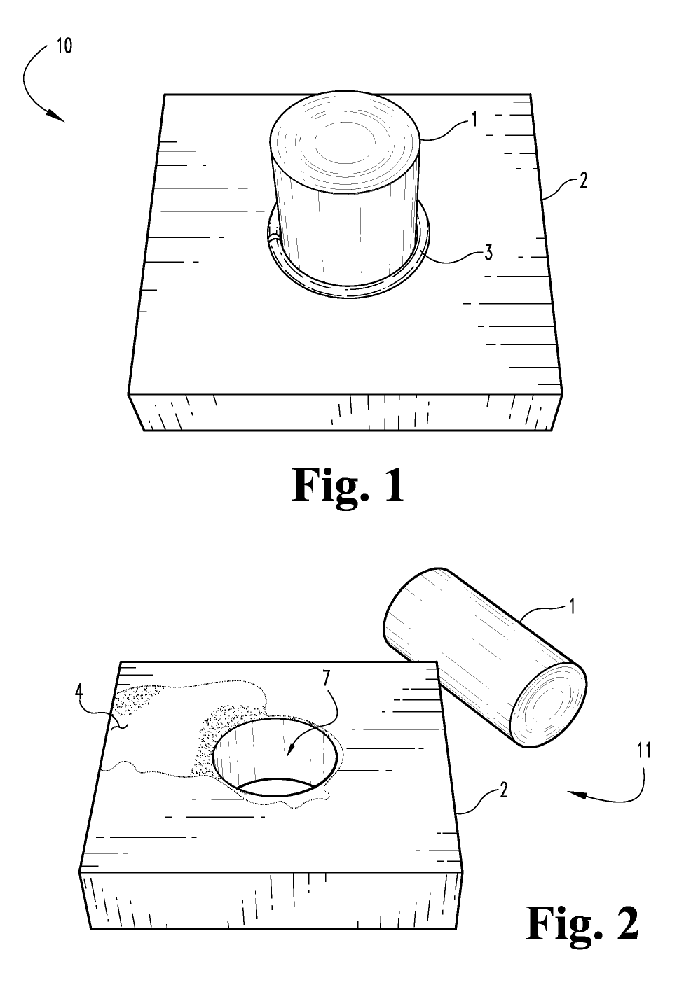

FIG. 1 illustrates the two members including, a pin 1 inserted into a plate 2, with a ring of brazing alloy 3 positioned about the upper intersection of the two members, prior to subjecting the combination 10 to a brazing temperature. Combinations of members and brazing alloys as illustrated in FIG. 1 were prepared and subjected to brazing temperatures in a brazing furnace in the following manner. The two members and brazing alloy were subjected to a temperature of about 2050° F. in an atmosphere of dissociated ammonia (an atmosphere of nitrogen with about 4% hydrogen can also be utilized) for about 20 minutes and allowed to cool. The resulting work piece was examined visually and the bond's shear strength determined by standard methods.

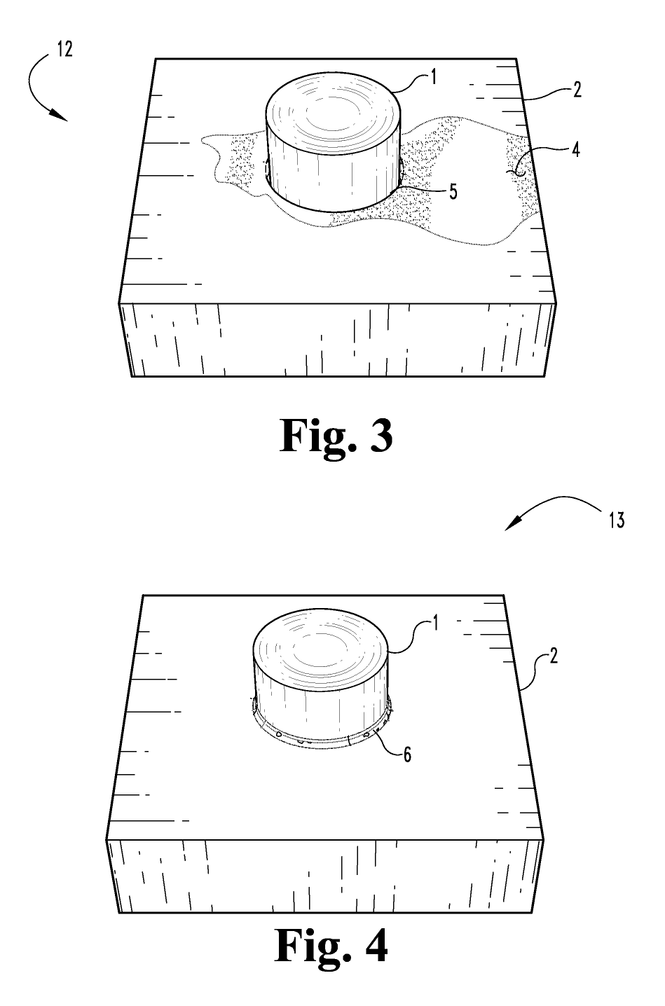

FIGS. 2-4 illustrate the work pieces 11, 12, and 13 where the gap between the pin 1 and plate 2 was about 0.003 of an inch. The brazing process failed to form a bond in work piece 11 (see FIG. 2) having a gap of 0.003 of an inch and prepared with CDA 110 alloy. Substantial puddling 4, of melted CDA 110 alloy also resulted. As a result, pin 1 was not properly bonded to plate 2 in work piece 11. FIG. 3 illustrates the resulting work piece 12, similarly having a 0.003 of an inch gap between pin 1 and plate 2 and formed as described above, with CDA 102 alloy. Pin 1 was weakly bonded to plate 2 with gap 5 partially filled with the brazing alloy. Again, substantial puddling 4 of the brazing alloy resulted. FIG. 4 illustrates a work piece 13 formed as described above, with the alloy from Example 1. In work piece 13, pin 1 was strongly bonded to plate 2 with gap 6 completely filled with the brazing alloy. No puddling of the brazing alloy was observed in work piece 13.

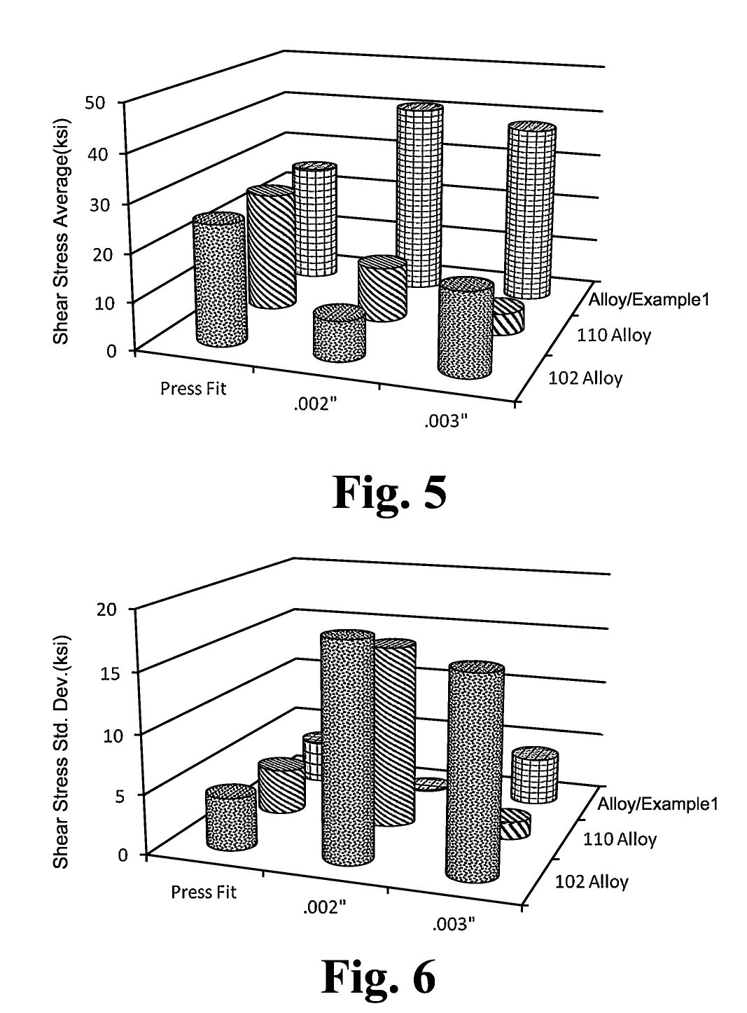

The procedures described above were repeated with additional members to form additional work pieces, where the gap between pin 1 and work piece 2 was a press fit, 0.002 of an inch and 0.003 of an inch and the brazing alloys utilized were CDA 102, CDA 110, and the alloy from Example 1. For the resulting work pieces, the shear strength (in ksi) and deviations in shear strength (in ksi) were determined. These results are summarized in Tables I and II below and FIGS. 5 and 6.

TABLE I

| | Shear Stress Average, ksi | | |
|---|---|---|---|
| Gap | Press Fit | 0.002 in. | 0.003 in. |
| CDA 102 Alloy | 25.27 | 8.45 | 16.92 |
| CDA 110 Alloy | 25.10 | 11.48 | 4.62 |
| Alloy/Example 1 | 25.24 | 40.75 | 38.03 |

The work pieces formed with CDA 102 alloy, CDA 110 alloy, and the alloy from Example 1 provided similar shear strengths when the gap was a press fit, but as the gap increased to the range from about 0.002 of an inch to about 0.003 of an inch, the shear strengths for the work pieces formed with the alloy from Example 1 substantially increased by more than 50% while the shear strengths of work pieces brazed with CDA 102 and CDA 110 decreased. This increase in shear strength with larger gaps was completely unexpected, and not a predictable result.

Table II illustrates the standard deviation achieved with each alloy at each different gap size. The standard deviation numbers should be read in conjunction with the results in Table I, because a repeated low shear strength as observed for CDA 110 alloy at a gap of 0.003 of an inch provided a very low standard deviation.

TABLE II

| | Shear Stress Standard Deviation, ksi | | |
|---|---|---|---|
| Gap | Press Fit | 0.002 in. | 0.003 in. |
| CDA 102 Alloy | 4.34 | 18.06 | 16.33 |
| CDA 110 Alloy | 3.83 | 15.46 | 1.35 |
| Alloy/Example 1 | 3.66 | 0.00 | 4.09 |

The results from Tables I and II are graphically provided in FIGS. 5 and 6, respectively. Similar results can be obtained when the wrought alloy ring is replaced with paste mixture of the powdered alloys included with a binder or flux.

The use of Applicants' claimed alloy for brazing operations provides the following advantages over conventional brazing alloys such as CDA 102, and CDA 110:
Improved wetting into braze joints with reduced puddling,
Consistent and reproducible bonding,
Improved joint quality, appearance, and strength,
Increased productivity, resulting from fewer reworks,
Cost savings resulting from reduced energy consumption resulting from fewer reworks,
Less scrap resulting from fewer unsatisfactory work pieces,
Improved throughput, and
The elimination of a need to use a flux.

The present invention contemplates modifications as would occur to those skilled in the art without departing from the spirit of the present invention. While the invention has been illustrated and described in detail in the foregoing description, the same is considered to be illustrative and not restrictive in character, it being understood that only the specific embodiments have been shown and described and that all changes and modifications that come within the spirit of the invention are desired to be protected.

1. A copper-based brazing alloy comprising about 0.1 to 10 wt. % zinc, about 0.1 to about 4 wt. % iron, and the balance copper.

2. The brazing alloy of claim 1 having a form selected from the group consisting of a wrought form and a powder form.

3. The brazing alloy of claim 2, wherein the form selected is a wrought from having a shape selected from the group consisting of a wire, a strip, a tube, a slug and a foil.

4. The brazing alloy of claim 2, wherein the brazing alloy selected is a powder form formulated as a paste.

5. The brazing alloy of claim 1 comprising about 4 wt. % zinc, about 2 wt. % iron, and about 94 wt. % copper.

6. A brazing process comprising;
(a) providing members having at least two surfaces adapted for bonding and a brazing alloy;
(b) positioning a brazing alloy proximate the at least two surfaces adapted for bonding;
(c) heating the at least two members and the brazing alloy to a temperature sufficient to melt the brazing alloy; and
(d) cooling the members and the brazing alloy to solidify the brazing alloy, wherein the brazing alloy comprises about 0.1 to 10 wt. % zinc, about 0.1 to about 4 wt. % iron, and the balance copper.

7. The process of claim 6, wherein providing a brazing alloy involves providing a brazing alloy having a form selected from the group consisting of a wrought form and a powder form.

8. The process of claim 6, wherein providing a brazing alloy involves providing a brazing alloy comprising about 4 wt. % zinc, about 2 wt. % iron, and about 94 wt. % copper.

9. The process of claim 6, wherein heating the at least two members and the brazing alloy to a temperature sufficient to melt the brazing alloy involves heating the at least two members to a temperature of about 1910° F. to about 2300° F.

10. A method for preparing a brazing alloy comprising:
(a) forming a mixture containing about 0.1 to about 4 wt. % iron, about 0.1 to about 10 wt. % zinc, and the balance copper;
(b) heating the mixture to a temperature sufficient to form a homogeneous molten mass; and
(c) transferring the molten mass into a three-dimensional form and solidifying said formed molten mass by cooling.

11. The method of claim 10, further involving a step of working the three-dimensional form into a wrought form.

12. The method of claim 10, further involving a step of grinding the three-dimensional form into a powder.

13. The method of claim 10, further involving a step of drawing the three-dimensional form into a wire.

14. A work piece including two members joined by a brazing alloy, wherein the brazing alloy comprises about 0.1 to 10 wt. % zinc, about 0.1 to about 4 wt. % iron, and the balance copper.

15. The work piece of claim 14, wherein the brazing alloy comprises about 4 wt. % zinc, about 2 wt. % iron, and about 94 wt. % copper.

16. The work piece of claim 14, wherein the brazing alloy is included in a gap between the two members forming a braze joint, and said gap is at least 0.002 of an inch.

17. The work piece of claim 16, wherein the braze joint has a shear strength of at least about 30 ksi.

18. The work piece of claim 14, wherein the brazing alloy further contains up to about 1 wt. % of individual components selected from the group consisting of silicon, manganese, aluminum, nickel, phosphorous, titanium, and combinations thereof, and the amount of copper contained in the brazing alloy is reduced by the amount of any additional selected components.

19. The work piece of claim 18, wherein the brazing alloy further contains up to about 0.2 wt. % of titanium.

20. The work piece of claim 14, wherein the work piece is a work piece selected from the group consisting of a torque converter, a muffler bracket, a fuel rail, an aircraft component, a water craft component, and a farm equipment component.
